(19) United States
(12) Patent Application Publication
(10) Pub. No.: US 2013/0286675 A1
(43) Pub. Date: Oct. 31, 2013

(54) HAZARDOUS-LOCATION-RATED LED LIGHT FIXTURE

(71) Applicants: Syed Q. Hasan, Sugar Land, TX (US); Anibal Z. Rosado, Pearlland, TX (US); William E. Martin, Crosswell, MI (US)

(72) Inventors: Syed Q. Hasan, Sugar Land, TX (US); Anibal Z. Rosado, Pearlland, TX (US); William E. Martin, Crosswell, MI (US)

(73) Assignee: RIG-A-LITE PARTNERSHIP, LTD., Houston, TX (US)

(21) Appl. No.: 13/458,726

(22) Filed: Apr. 27, 2012

(51) Int. Cl. F21S 8/10; F21L 4/02; F21L 4/08; F21S 4/00

(52) U.S. Cl. 362/543; 362/225; 362/184; 362/183

(57) ABSTRACT

A light fixture (2) that has at least one explosion-proof transparent tube (8) having first and second ends, as well as first and second fixture ends (4, 6) attached to the first and second ends of the at least one transparent tube (8). The fixture ends (4, 6) define openings (42) arranged and designed to provide access to the interior of the at least one transparent tube (8). The light fixture (2) further includes a plurality of removable caps (40) arranged and designed to close and seal the openings (42), and a plurality of light emitting diodes (12) arranged and designed to be positioned within the at least one transparent tube (8) and to emit light through the tube (8).

### BACKGROUND OF THE INVENTION

1. Field of the Invention

This invention relates generally to hazardous-location-rated fixtures, and specifically to fixtures lit by light emitting diodes.

2. Description of the Prior Art

Fixtures for use within hazardous locations are well known. In the 1920s, the National Electric Code addressed requirements for fixtures to be located in rooms or compartments in which highly flammable gases, liquids, mixtures or other substances were manufactured, used or stored. Starting in the 1930s, the NEC began defining hazardous location classifications.

Today, a worldwide industry exists for setting performance standards for devices which operate within hazardous locations and for certifying those devices which meet those standards. For example, Underwriters Laboratories (UL), National Fire Protection Association (NFPA), American National Standards Institute (ANSI), National Electrical Manufacturers Association (NEMA), Canadian Standards Association (CSA), International Electrotechnical Commission (IEC), and European Committee for Electrotechnical Standardization (CENELEC) all publish standards for equipment or fixtures to be located in various hazardous locations.

The various hazardous area classifications form a framework which can be used to summarize the accepted protection methods approved for use. For example, for areas where ignitable concentrations of flammable gases, vapors or liquids can exist all of the time or some of the time under normal operating conditions, accepted protection methods for fixtures include, for example, explosion-proof construction.

Accordingly, explosion-proof light fixtures are well known in the prior art. For example, Rig-A-Lite Partnership, Ltd., of Houston, Tex. manufactures a variety of light fixtures for use in hazardous conditions. Such fixtures include incandescent as well as fluorescent light fixtures. One feature that is common among the explosion-proof light fixtures is that the lighting elements within the fixtures are protected by explosion-proof casings or housings. Often, the area immediately around the light bulbs is sealed from the outside environment. For example, one known fluorescent light fixture provides explosion-proof glass tubes that encase the fluorescent light bulbs. Such glass tubes are designed to contain any explosion that may occur within the fixture.

While fluorescent and other types of explosion-proof light fixtures are available for use in hazardous applications, these fixtures have shortcomings. For example, incandescent and fluorescent lights are not as efficient as some other types of lighting, such as, for example, light emitting diodes (LEDs). In addition, in particular in the case of fluorescent lights, the quality of the light produced is less than that provided by LEDs. The problem with using LEDs in explosion-proof light fixtures, however, is that LEDs are very sensitive to heat. This feature has heretofor prevented wide use of LEDs in explosion-proof light fixtures because enclosing the LEDs in a sealed, explosion-proof glass casing traps the heat generated by the LEDs, thereby raising the temperature around the LEDs, causing them to perform poorly.

3. Identification of Objects of the Invention

An object of the invention is to provide an LED light fixture that overcomes the disadvantages of the prior art.

Another object of the invention is to provide an LED light fixture where the light emitting diodes are enclosed within a glass tube and heat is dissipated away from the enclosure.

Another object of the invention is to provide a light fixture suitable for use in areas with a hazardous or potentially hazardous atmosphere.

Another object of the invention is to provide a light fixture suitable for use in areas with a hazardous or potentially hazardous atmosphere that eliminates the requirement for external redundant power by including an internal battery backup.

### SUMMARY OF THE INVENTION

The objects identified above, as well as other features of one or more embodiments of the invention are incorporated in a light fixture having at least one explosion-proof transparent tube having first and second ends, and first and second fixture ends attached to the first and second ends of the at least one transparent tube, the fixture ends defining openings arranged and designed to provide access to the interior of the at least one transparent tube. The light fixture also includes a plurality of removable caps arranged and designed to close and seal the openings, and a plurality of LEDs arranged and designed to be positioned within the at least one transparent tube and to emit light through the tube. In addition, the light fixture includes at least one LED circuit panel attached to the LEDs, and a support member in thermal communication with the at least one LED circuit panel and with the first and second fixture ends so that heat generated by the LEDs is dissipated through the support member and the first and second fixture ends away from the at least one transparent tube.

One embodiment of the invention provides a light fixture having at least one explosion-proof transparent tube having first and second ends and containing light emitting diodes, and first and second fixture ends sealingly engaged with the first and second ends of the at least one transparent tube. This embodiment also includes a reflector attached to the first and second fixture ends adjacent to the at least one transparent tube, and a battery attached to the reflector and arranged and designed to provide power to a subset of the LEDs within the at least one tube, thereby enabling the subset of the LEDs to remain lit in the absence of an external power source.

Another embodiment of the invention provides a light fixture having at least one explosion-proof transparent tube having first and second ends and containing LEDs, and first and second fixture ends attached to the first and second ends of the at least one transparent tube, the fixture ends defining openings arranged and designed to provide access to the interior of the at least one transparent tube to provide access to the LEDs. In this embodiment, a vehicle is attached to the first and second fixture ends to allow porting of the light fixture from one place to another.

### BRIEF DESCRIPTION OF THE DRAWINGS

The invention is described in detail hereinafter on the basis of the embodiments represented in the accompanying figures, in which:

FIG. 1 is a perspective view of the LED fixture according to an embodiment of the present invention;

FIG. 2 is a bottom view of the LED fixture of FIG. 1;

FIG. 3 is a side perspective view of the LED fixture of FIG. 1;

FIG. 4 is a perspective view of an LED strip according to an embodiment of the present invention;

FIG. 5A is a side view of the first fixture end of the LED fixture of FIG. 1, with the end caps in place;

FIG. 5B is a sectional perspective view of the first fixture end of the LED fixture of FIG. 1, with the end cap removed and the LED strip partially inserted into a transparent tube of the fixture;

FIG. 5C is a sectional perspective view of the first fixture end of the LED fixture of FIG. 1, with one end cap removed and showing the hardware used to mount the LED strip within a transparent tube of the light fixture;

FIG. 6A is a side view of the second fixture end of the LED fixture of FIG. 1, with the end caps in place;

FIG. 6B is a sectional side view of the second fixture end of the LED fixture of FIG. 1 with an end cap removed to show the hardware used to mount an LED strip within a tube;

FIG. 7 is an enlarged view of the backup LEDs according to an embodiment of the present invention; and

FIG. 8 is an alternative embodiment of the present invention, in which the LED fixture is portable.

### DESCRIPTION OF THE PREFERRED EMBODIMENT OF THE INVENTION

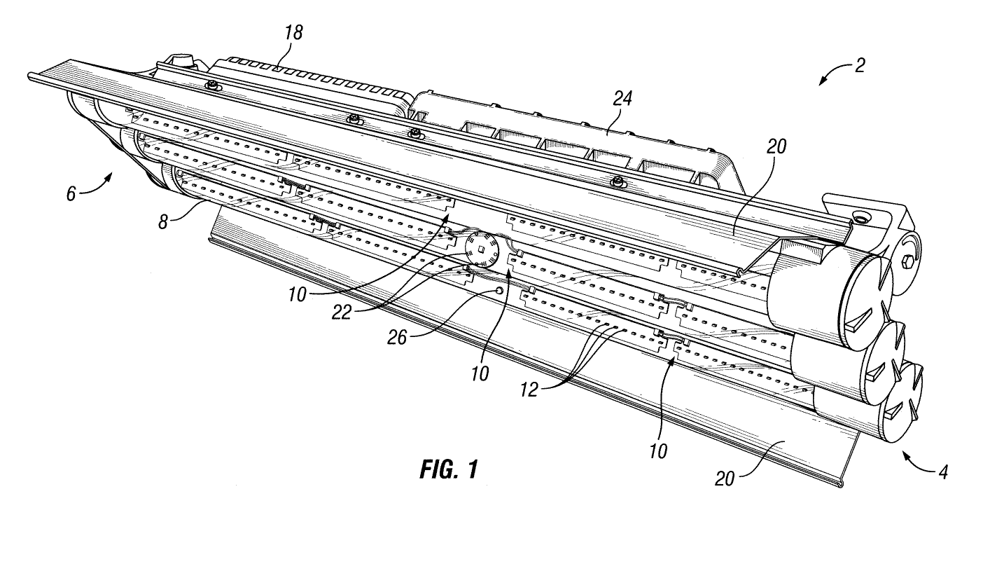

Referring to FIG. 1, there is shown a perspective view of an LED fixture 2 according an embodiment of the present invention. The LED fixture 2 includes first and second fixture ends 4, 6 that are attached to a plurality of longitudinal transparent tubes 8. The tubes 8 are preferably fixedly attached to the first and second fixture ends 4, 6, and the intersection between the tubes 8 and the fixture ends 4, 6 is preferably sealed. The tubes may be sealed to the fixture ends, for example, with a cement compound. The LED fixture further includes LED strips 10 contained within the tubes 8. Each LED strip 10 includes a plurality of individual LEDs 12, which are preferably arranged in substantially straight lines along the LED strips 10. The LEDs 12 of each strip 10 are wired in a circuit, as is known in the prior art. All of the LEDs 12 are ultimately electrically connected to a common circuit that draws current through a ballast 18, which is preferably externally mounted so as to be easily accessible. The ballast is preferably thermally protected and cold weather rated, and may be finned, to provide for greater heat dissipation and extended ballast life. In addition, the LED fixture 2 includes reflectors 20, which may have a high-gloss reflective finish, and which may be resistant to dents and corrosion.

In the preferred embodiment, the LED fixture 2 is suitable for use in hazardous or hostile locations where fire or explosion may exist due to flammable gases or vapors, flammable liquids, combustible dust, and/or ignitable fibers or flyings. For example, the tubes 8 are preferably made of impact and heat resistant glass. Examples of hazardous environments where the fixture may be used include, for example, oil rigs, refineries, chemical plants, wastewater treatment facilities, and paint booths. In addition, the LED fixture 2 may also be suitable for installation in wet locations and marine environments where it may be subjected to salt water spray or other moisture. For example, first and second fixture ends 4, 6 may preferably be made of corrosion-resistant aluminum that is substantially free of copper (e.g., where the copper content is less than about 0.4%). In addition, the reflectors 20 may be made of heavy gauge aluminum capable of resisting corrosion.

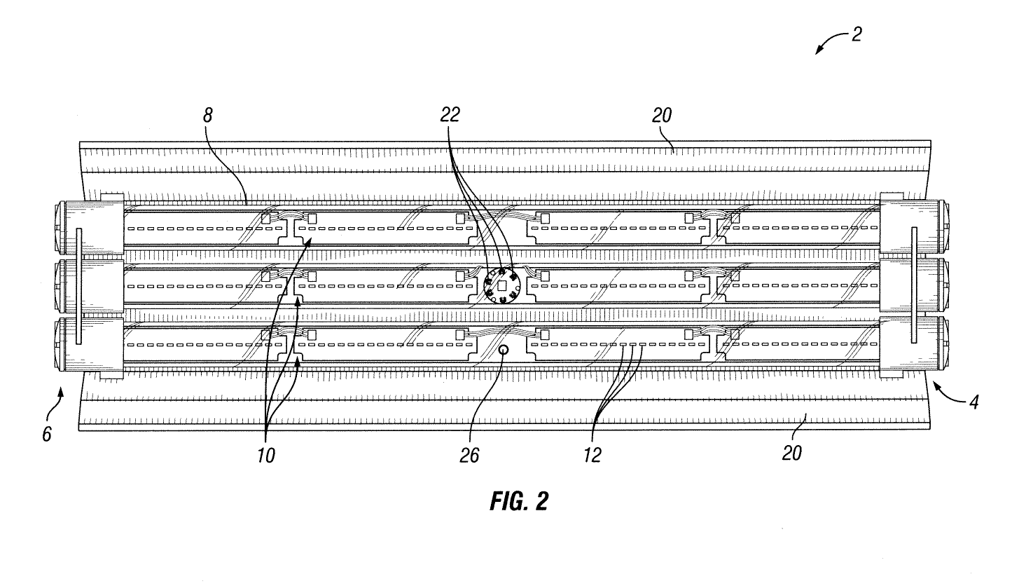

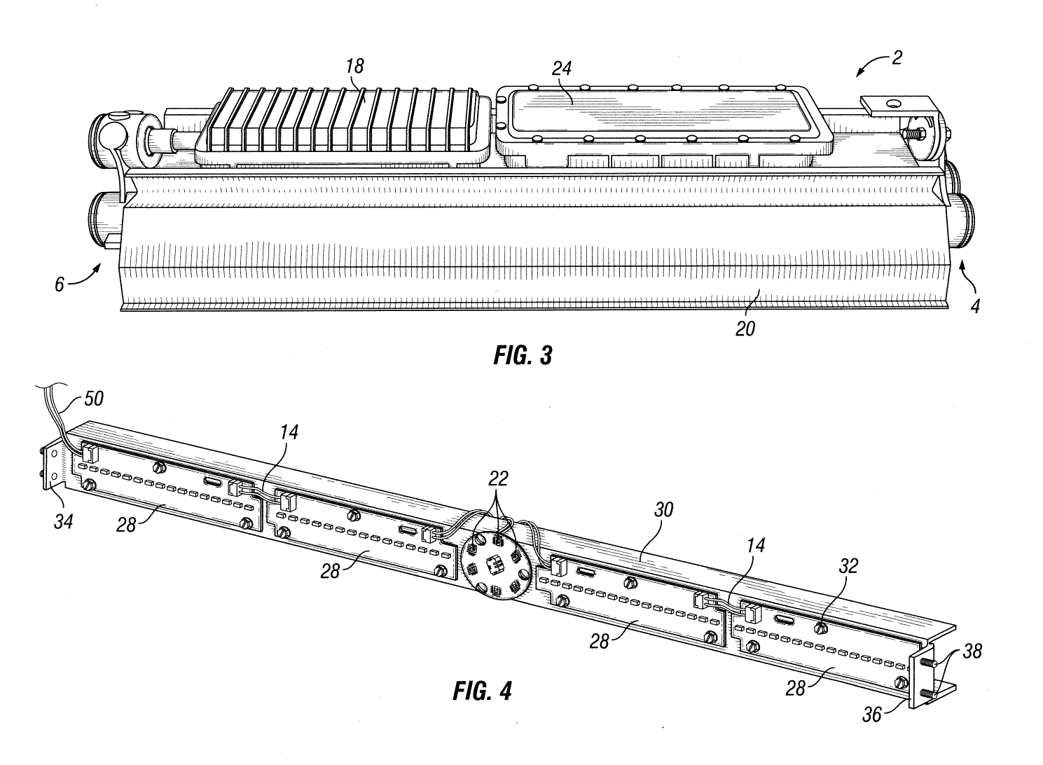

FIGS. 2 and 3 show a bottom view and a perspective side view of the LED fixture 2, respectively. As shown in FIG. 2, at least one of the LED strips 10 includes backup LEDs 22. Backup LEDs 22 may be arranged in a circular configuration, as shown, or in any other configuration. In addition, backup LEDs 22 may be included on one LED strip 10, as shown, or may be included on a plurality of LED strips 10. Backup LEDs 22 are wired to a separate backup circuit. The backup circuit is powered by a rechargeable battery 24 (shown in FIG. 3). Because they are powered by a battery, and not by an external power source, backup LEDs 22 may be illuminated in the event of a power failure. The LED fixture 2 may also include an indicator light 26 that illuminates when the battery 24 is recharging, thereby giving visual indication of whether the battery is fully charged.

Referring now to FIG. 4, there is shown an LED strip 10 that has been removed from the longitudinal transparent tube 8 (shown in FIGS. 1 and 2) of the fixture. As can be seen, LED strip 10 includes a plurality of individual LEDs 12 mounted on discrete circuit panels 28. Each of the circuit panels 28 is electrically connected by wires 14. Each of the circuit panels 28 is attached to LED support member 30, which is preferably made of aluminum or other metal. One reason that the LEDs are configured in this way is to control the heat dissipation within the transparent tubes. LEDs are sensitive to heat, thereby requiring that the heat generated within the tubes be dissipated to keep the temperature within the tubes at an acceptably low level. The configuration of the present invention effectively achieves this requirement. For example, the LED circuit panels 28 are mounted to the metal support member 30, which is in turn attached to the aluminum first and second fixture ends 4, 6 (as discussed in more detail below). Thus, heat generated by the LEDs is dissipated along the support member 30 toward the fixture ends, then through the fixture ends away from the interior of the tubes 8. In this way, the amount of heat within the tubes is managed effectively so that the LEDs within the tubes can continue to function. In the embodiment depicted in FIG. 4, the LED support member 30 has a U-shape to increase rigidity. Alternatively, the LED support member 30 may be other than a U-shaped profile. In addition, LED circuit panels 28 may be attached to the LED support member 30 by any acceptable means, such as, for example, through the use of screw fasteners 32, as shown.

FIG. 4 also shows the structure that allows for mounting the LED strips 10 within the longitudinal transparent tubes 8. In particular, each LED strip 10 has a pair of transverse flanges 34, 36, extending from the ends of the strip 10. Threaded male posts 38 are attached to the flanges 34, 36. As will be explained in further detail below, the threaded male posts 38 are configured to correspond to receiving hardware in the first and second fixture ends 4, 6. Each LED strip 10 is completely removable from the tubes 8 of the LED fixture 2. Accordingly, the components of the LED strips 10 can be easily accessed for maintenance and repair, such as, for example, to replace individual LEDs 12, etc.

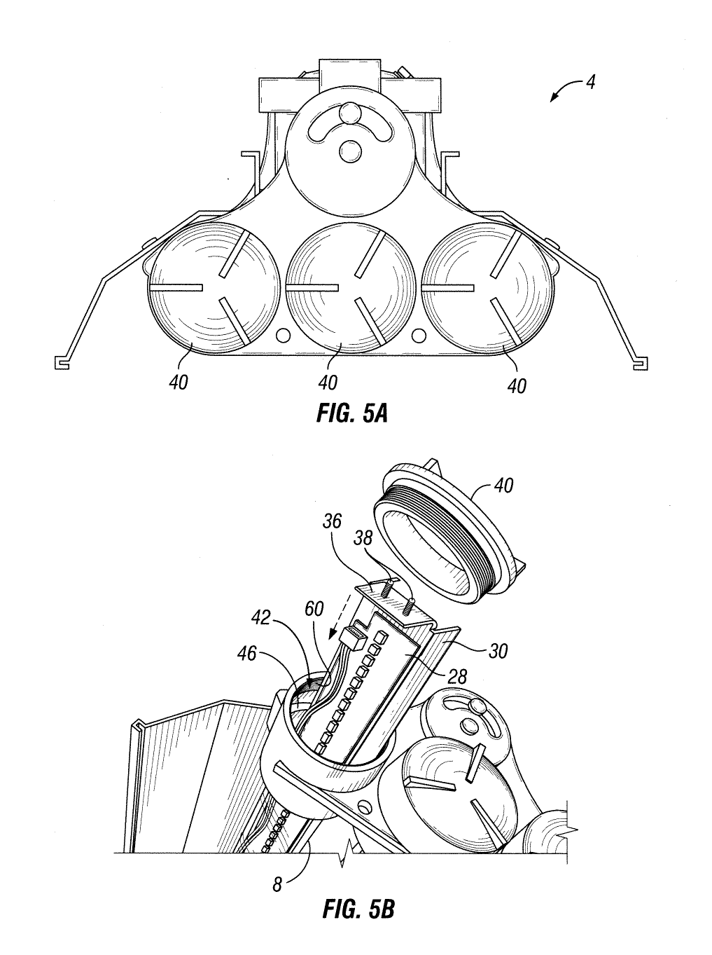

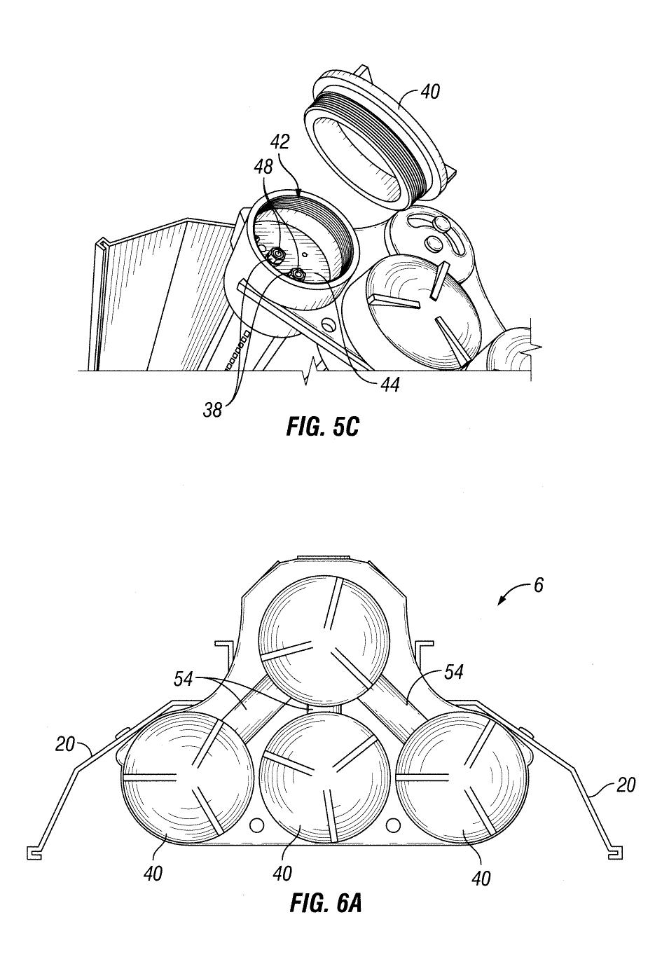

FIGS. 5A-5C show the first fixture end 4 of the LED fixture 2 according to an embodiment of the present invention. FIG. 5A shows the first fixture end 4 with end caps 40 in place. End caps 40 are arranged and designed to plug and seal openings 42 (shown in FIGS. 5B and 5C), which openings 42 allow access to the inside of transparent tubes 8. Preferably, end caps 40 are configured to threadedly engage the fixture end and, when closed and tightened, seal the openings 42. The end caps 40 may include an o-ring seal, or any other appropriate seal, to help seal the openings 42.

As shown in FIG. 5B, when the LED fixture is assembled, LED strip 10 is inserted into tube 8 through the opening 42 in the end of the fixture. FIG. 5B shows the LED strip 10 in a partially inserted position. As can be seen, the inner diameter of the opening 42 has a step 46. This step results from the difference in diameters between the end cap receiving portion 60 of the opening 42, and the internal diameter of the transparent tube 8. When the LED strip 10 is fully inserted into the tube 8, the flange 34, 36 of the LED strip 10 is positioned inside the step 46, with the male posts 38 extending beyond the step 46 toward the end cap receiving portion 60 of the opening 42.

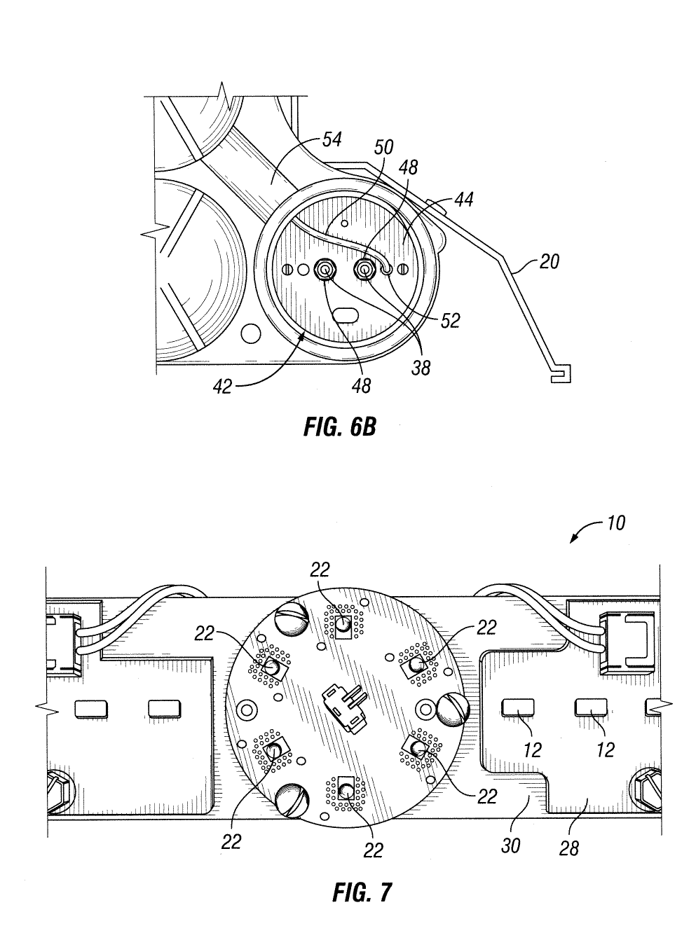

As shown in FIG. 5C, when the LED strip 10 is in place inside the transparent tube 8, a plate 44 is inserted into the opening 42. The diameter of the plate 44 is larger than the diameter of the interior of the tube 8, so that the plate rests on the step 46 and cannot pass to the inside of the tube 8. The plate 44 also has openings that correspond to the male posts 38 of the LED strip 10 such that when the plate 44 is seated on the step 46, the male posts 38 pass through the openings in the plate 44. Thereafter, fasteners 48, such as threaded nuts, are placed over the male posts 38 to secure the posts 38 to the plate 44. The other end of the LED strip 10 is fastened in a similar manner at the second fixture end 6 (as shown in FIG. 6B), as discussed below. Thus, the LED strip is securely held at both fixture ends 4, 6. With the LED strip 10 fixed in the tube 8, the end cap 40 is replaced, thereby sealing the opening 42. In this way, each LED strip 10 may be sealed within a respective transparent tube 8.

FIGS. 6A and 6B show the second fixture end 6 of a preferred embodiment of the invention. FIG. 6A shows the second fixture end 6 with end caps 40 in place. End caps 40 are arranged and designed to plug and seal openings 42 (shown, e.g., in FIG. 6B), which openings 42 allow access to the inside of transparent tubes 8. Similar to the structure described above with regard to FIGS. 5B and 5C, the openings 42 are configured to accept a plate 44. The plate 44 in turn, receives male posts 38 of the end of LED strip 10, which posts may be secured to the plate 44 by fasteners 48, which may be, for example, threaded nuts.

In addition, FIGS. 6A and 6B show the way in which the LED strips 10 are electrically connected to one another and to a power source. For example, FIG. 6B shows electric wire 50, which is attached to the LED strip 10 inside the tube 8 (see, e.g., FIG. 2). Wire 50 extends through opening 52 in plate 44 to provide electrical communication between the LED strip, which is isolated in tube 8, and other electrical components of the fixture. From the opening 52 in the plate 44, electric wire 50 passes through port 54 to a wiring junction (not shown) within the second fixture end 6. Wires connecting additional LED strips 10 of the LED fixture 2 pass from other openings 42 to the wiring junction via other ports 54 (shown in FIG. 6A). Current is provided to the wires at the wire junction by means of the incoming A/C power and the ballast 18, according to known methods. Preferably, the fixture is configured to operate on either 120V, 277V 60 Hz, or 220V 50 Hz, depending on the power connection available at a given site.

FIG. 7 shows an enlarged view of the backup LEDs 22 according to one embodiment of the invention. As discussed above, the backup LEDs 22 are powered by a battery 24, which may be mounted on top of the LED fixture 2 and attached to the reflector 20. Because the backup LEDs 22 are powered by a battery source, they will continue to light even if external power to the LED fixture fails. In addition, when external power fails, the LED fixture automatically switches to the emergency mode, keeping the backup LEDs illuminated. This feature is advantageous as a safety feature because it ensures that if power is lost, for example, in an emergency, the area around the fixture will remain lit to permit egress. Preferably, the battery 24 that powers the backup LEDs 22 is rechargeable, thereby reducing maintenance costs resulting from constant changing of worn batteries. The battery may preferably be a high temperature nickel cadmium battery. The backup LEDs 22 may be configured on the LED strip 10 in any manner, and are not limited to the circular configuration shown in the drawings.

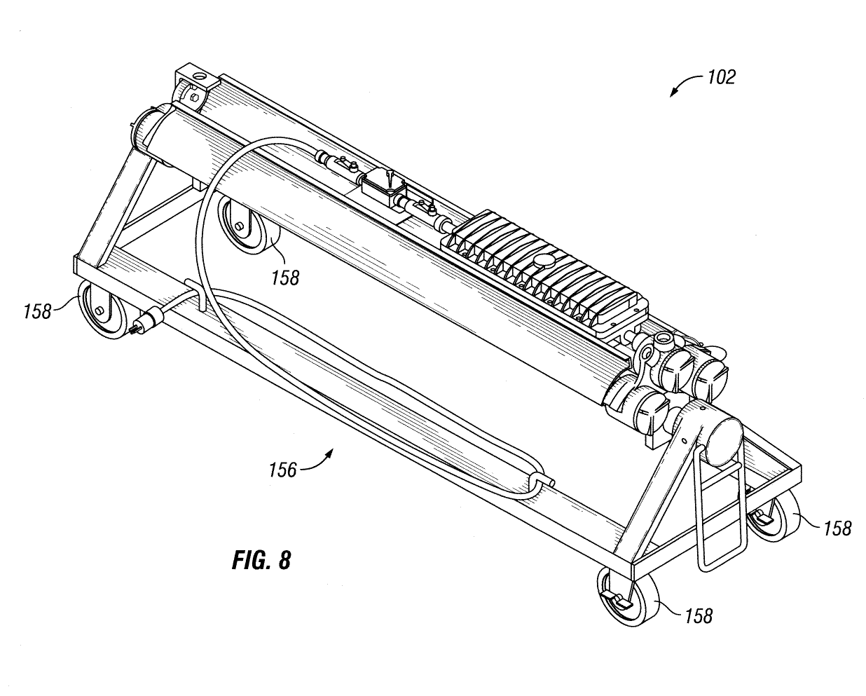

FIG. 8 shows another preferred embodiment of the present invention. In this embodiment, the LED fixture 102 is mounted on a vehicle 156 having wheels 158. Such an arrangement makes the LED fixture 102 portable. This portability may increase the usefulness of the LED fixture in certain applications, such as for example, mechanic's shops, etc.

While the preferred embodiment of the invention has been illustrated in detail, the invention is not limited to the embodiment shown. It is apparent that modifications and adaptations of the above embodiment may occur to those skilled in the art. Such modifications and adaptations are in the spirit and scope of the invention as set forth herein.

What is claimed is:

1. A light fixture (2), comprising:
at least one explosion-proof transparent tube (8) having first and second ends;
first and second fixture ends (4, 6) attached to the first and second ends of the at least one transparent tube (8), the fixture ends (4, 6) defining openings (42) arranged and designed to provide access to the interior of the at least one transparent tube (8);
a plurality of removable caps (40) arranged and designed to close and seal the openings (42); and
a plurality of light emitting diodes (LEDs) (12) arranged and designed to be positioned within the at least one transparent tube (8) and to emit light through the tube (8).

2. The light fixture (2) of claim 1, further comprising,
at least one LED circuit panel (28) attached to the LEDs (12); and
a support member (30) in thermal communication with the at least one LED circuit panel (28) and with the first and second fixture ends (4, 6) so that heat generated by the LEDs (12) is dissipated through the support member (30) and the first and second fixture ends (4, 6) away from the at least one transparent tube (8).

3. The light fixture (2) of claim 1, wherein the at least one explosion-proof transparent tube (8) is in sealed engagement with the first and second fixture ends (4, 6).

4. The light fixture (2) of claim 1, wherein the first and second fixture ends (4, 6) are made of corrosion resistant aluminum.

5. The light fixture (2) of claim 4, wherein the aluminum of the first and second fixture ends (4, 6) includes less than about 0.4% copper.

6. The light fixture (2) of claim 1, further comprising,
a reflector (20) attached to the first and second fixture ends (4, 6) and positioned adjacent the at least one explosion-proof transparent tube (8).

7. The light fixture (2) of claim 6, wherein the reflector (20) is made of heavy gauge aluminum.

8. The light fixture (2) of claim 1, further comprising,
an external power supply; and
a ballast (18) electrically connected to the external power supply and to the plurality of LEDs (12), thereby delivering power to the LEDs (12).

9. The light fixture (2) of claim 6, further comprising
a battery (24) attached to the reflector (20); and
a plurality of backup LEDs electrically connected to the battery (24) for providing light.

10. The light fixture (2) of claim 9, wherein the battery (24) is rechargeable.

11. A light fixture (2), comprising:
at least one explosion-proof transparent tube (8) having first and second ends and containing light emitting diodes (LEDs) (12);
first and second fixture ends (4, 6) sealingly engaged with the first and second ends of the at least one transparent tube (8);
a reflector (20) attached to the first and second fixture ends 4, 6) adjacent to the at least one transparent tube (8); and
a battery (24) attached to the reflector (20) and arranged and designed to provide power to a subset of the LEDs (22) within the at least one tube (8), thereby enabling the subset of the LEDs (22) to remain lit in the absence of an external power source.

12. The light fixture (2) of claim 11, further comprising,
at least one LED circuit panel (28) attached to the LEDs (12); and
a support member (30) in thermal communication with the at least one LED circuit panel (28) and with the first and second fixture ends (4, 6) so that heat generated by the LEDs (12) is dissipated through the support member and the first and second fixture ends (4, 6) away from the at least one transparent tube (8).

13. The light fixture (2) of claim 11, wherein the at least one explosion-proof transparent tube (8) is made of impact and heat resistant glass.

14. The light fixture (2) of claim 11, wherein the first and second fixture ends (4, 6) are made of corrosion resistant aluminum.

15. The light fixture (2) of claim 14, wherein the aluminum of the first and second fixture ends includes less than about 0.4% copper.

16. The light fixture (2) of claim 11, wherein the reflector (20) is made of heavy gauge aluminum.

17. The light fixture (2) of claim 11, further comprising,
an external power supply; and
a ballast (18) electrically connected to the external power supply and to at least a portion of the plurality of LEDs (12), thereby delivering power to at least a portion of the LEDs (12).

18. The light fixture (2) of claim 11, wherein the battery (24) is rechargeable.

19. A portable light fixture (102), comprising:
at least one explosion-proof transparent tube (8) having first and second ends and containing light emitting diodes (LEDs) (12);
first and second fixture ends (4, 6) attached to the first and second ends of the at least one transparent tube (8), the fixture ends defining openings (42) arranged and designed to provide access to the interior of the at least one transparent tube (8) to provide access to the LEDs (12);
at least one LED circuit panel (28) attached to the LEDs (12);
a support member (30) in thermal communication with the at least one LED circuit panel (28) and with the first and second fixture ends (4, 6) so that heat generated by the LEDs (12) is dissipated through the support member (30) and the first and second fixture ends (4, 6) away from the at least one transparent tube (8); and
a vehicle (156) attached to the first and second fixture ends (4, 6) to allow porting of the light fixture (102) from one place to another.
